(19) United States
(12) Patent Application Publication
(10) Pub. No.: US 2008/0052776 A1
(43) Pub. Date: Feb. 28, 2008

(54) Method and apparatus of an unintrusive plug and play application virtualization platform

(75) Inventors: Kumar Prabhat, San Jose, CA (US); Santosh Kumar, San Jose, CA (US); Karthik Guruswamy, San Jose, CA (US)

Correspondence Address: Raj Abhyanker, LLP;c/o Intellevate, P.O. Box 52050, Minneapolis, MN, 55402, US

(73) Assignee: Nomadrive, Inc.

(21) Appl. No.: 11/698,478

(22) Filed: Jan. 26, 2007

Related U.S. Application Data
(60) Provisional application No. 60/823,635, filed on Aug. 25, 2006.

(51) Int. Cl. G06F 15/16

(52) U.S. Cl. 726/15

(57) ABSTRACT

A method and apparatus of an unintrusive plug and play application virtualization platform is disclosed. In one embodiment, a method includes capturing dependencies of an application program associated with a host system, directly replicating to a removable device the application program, a desktop environment of the host system, and the dependencies and resurrecting the dependencies to run the application program under the desktop environment agnostic to a guest operating system (OS) of a guest system while the removable device is coupled to the guest system. The method may also include duplicating a desktop element of the host system to the desktop environment of the removable device. In addition, the method may include storing a user name and a password associated with the removable device to access the desktop environment when the removable device is coupled to the guest system.

### CLAIM OF PRIORITY

This application claims priority form provisional application 60,823,635 titled “Application Virtualization for Application Portability with Plug and Play” filed on Aug. 25, 2006

### FIELD OF TECHNOLOGY

This disclosure relates generally to the technical fields of software and/or hardware technology and, in one example embodiment, to method and apparatus of an unintrusive plug and play application virtualization platform.

### BACKGROUND

A user may frequently use several applications (e.g., Microsoft office®, Quick books®, Open Office®, etc.) to perform a task. When the user works with a guest computer (e.g., a computer which the user may not have the administrative privilege with), the guest computer may not have an application which the user may need. In addition, it may not be realistic for the user to install the application on the computer because it may take time to install the application and/or it may require the user to purchase a license and/or obtain an administrative privilege to use the guest computer.

Alternatively, the user may install the application and/or data from a host computer (e.g., a computer which the user may have the administrative privilege with) to the guest computer. To customize the guest computer with the application and/or the data, the user may have run a set up program to install the application and/or the data on the guest computer, thus subjecting the user a time consuming process.

In addition, a context (e.g., a desktop environment, a data file, etc. associated with the application) of the application installed on the guest computer may slow down a performance of the application. Moreover, the user may lose the context of the application generated during a usage of the guest computer once the user logs out of the guest computer. Furthermore, the user may have to spend time and/or energy removing the application, the data, and/or other modifications to the guest computer once the user is done using the guest computer.

### SUMMARY

A method and apparatus of an unintrusive plug and play application virtualization platform is disclosed. In one aspect, a method includes capturing dependencies (e.g., the dependencies may include a host operating system to provide a memory and/or a disk space, a host file system to read and/or write data, and/or a host registry to store and/or retrieve the data) of an application program (e.g., the application program 104 of FIG. 1) associated with a host system, directly replicating to a removable device the application program, a desktop environment of the host system, and the dependencies (e.g., the dependencies 106 of FIG. 1) and resurrecting the dependencies to run the application program under the desktop environment (e.g., the desktop environment 108 of FIG. 1) agnostic to a guest operating system (OS) of a guest system while the removable device is coupled to the guest system.

In addition, the method may include duplicating any one of the desktop element (e.g., the desktop element may include an icon, a toolbar, a wall paper, and/or a document) of the host system to the desktop environment of the removable device. Furthermore, the method may include storing a user name and a password associated with the removable device to access the desktop environment when the removable device is coupled to the guest system.

Also, the method may include executing the application program faster on the guest system (e.g., the guest system 114 of FIG. 1) than on the host system by at least 20% through a performance tuning (e.g., the performance tuning may be obtained through a code optimization, a load balancing, a caching strategy, and/or a distributed computing) of an application program interface (API) of the application program embedded in the removable device.

Moreover, the method may include matching the user name and the password communicated to the removable device to authenticate a user of the removable device when the removable device is coupled to the guest system. The method may also include switching between the desktop environment of the removable device and the desktop environment of the guest system.

Furthermore, the method may also include isolating the application program of the removable device from any application program of the guest system to prevent any conflict between the application program of the removable device and the any application program of the guest system. Moreover, each of the host system and the guest system may be a personal computer and the removable device may be a USB drive with a flash memory.

In another aspect, a method includes capturing a host state (e.g., the host state may include a state of a registry of a host system and/or a state of a file system of the host system) of a host system immediately prior to directly installing an application program to a removable device, replicating the host state and changes of the host state to the removable device based on the changes of the host state captured during the installing the application program to the removable device, deleting the changes and reinstating a dynamically linked library (DLL) of the host state to the host system to restore the host state to the host system.

The method may further includes capturing a guest state (e.g., the guest state may include the state of the registry of the guest system and/or the state of the file system of the guest system) of a guest system immediately prior to coupling the removable device to the guest system and changes of the guest state during the coupling and/or deleting the changes and reinstating the dynamically linked library (DLL) of the guest state to the guest system to restore the guest state to the guest system.

The method may also include capturing the changes of the registry of the host system and/or the changes of the registry of the guest system through turning on a security auditing and/or capturing the changes of the file system of the host system and/or the changes of the file system of the guest system through activating a file system watcher. In addition, the method may include replicating the changes to the removable device when the removable device is decoupled from the guest system.

In yet another aspect, a removable device includes an installation module of an application virtualization platform to replicate to the removable device through a host system with an application program, a desktop environment of the host system, and/or dependencies of the application program associated with the host system, a link module of the application virtualization platform to load the application program, the desktop environment, and/or the dependencies to a guest system when the removable device is coupled to the guest system and an execution module of the application virtualization platform to generate a virtual environment such that the application program operates agnostic to an operating system (OS) of the guest system.

Furthermore, the system may include a customization module to selectively replicate the desktop environment of the host system to the removable device through enabling a user of the removable device to selectively import any number of desktop elements to the removable device. Also, the system may include an acquisition module of the installation module to detect and/or capture any one of the dependency of the application program. The system may further include an interface detection module of the link module to determine a coupling and/or a decoupling of the removable device from the guest system.

In addition, the system may include a layer module of the execution module to create a rule based virtualization layer through hooking the application program interface (API) of the application program and installing at least one handler associated with the application program. Moreover, the system may include a virtualization module of the execution module to create the virtual environment through virtualizing calls associated with a registry, a file system, and the API of the application program such that the application program operates under the virtual environment using the handler.

The methods, systems, and devices disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system view of the mobile device having the application virtualization platform communicating with the host system and the guest system, according to one embodiment.

FIG. 2 is an exploded view of the application virtualization platform of FIG. 1, according to one embodiment.

FIG. 3 is a process view of the installation module of FIG. 2, according to one embodiment.

FIG. 4 is a process view of the link module of FIG. 2, according to one embodiment.

FIG. 5 is a process view of the execution module of FIG. 2, according to one embodiment.

FIG. 6 is a user interface view of the customization module 204, according to one embodiment.

FIG. 7 is a diagrammatic system view of a data processing system in which any of the embodiments disclosed herein may be performed, according to one embodiment.

FIG. 8 is a schematic view of replicating an application program from a host computer to a guest computer by using a removable device, according to one embodiment.

FIG. 9 is a process flow chart of capturing the application program, the desktop environment, and the dependencies of the host system of FIG. 1 using the mobile device, according to one embodiment.

FIG. 10 is a process flow chart of capturing, replicating, and/or deleting a host state and/or a guest state using the mobile device of FIG. 1, according to one embodiment.

Other features of the present embodiments will be apparent from the accompanying drawings and from the detailed description that follows.

### DETAILED DESCRIPTION

A method and apparatus of an unintrusive plug and play application virtualization platform is disclosed. In the following description, for purposes of explanation, numerous specific details are set forth in order to provide a thorough understanding of the various embodiments. It will be evident, however, to one skilled in the art that the various embodiments may be practiced without these specific details.

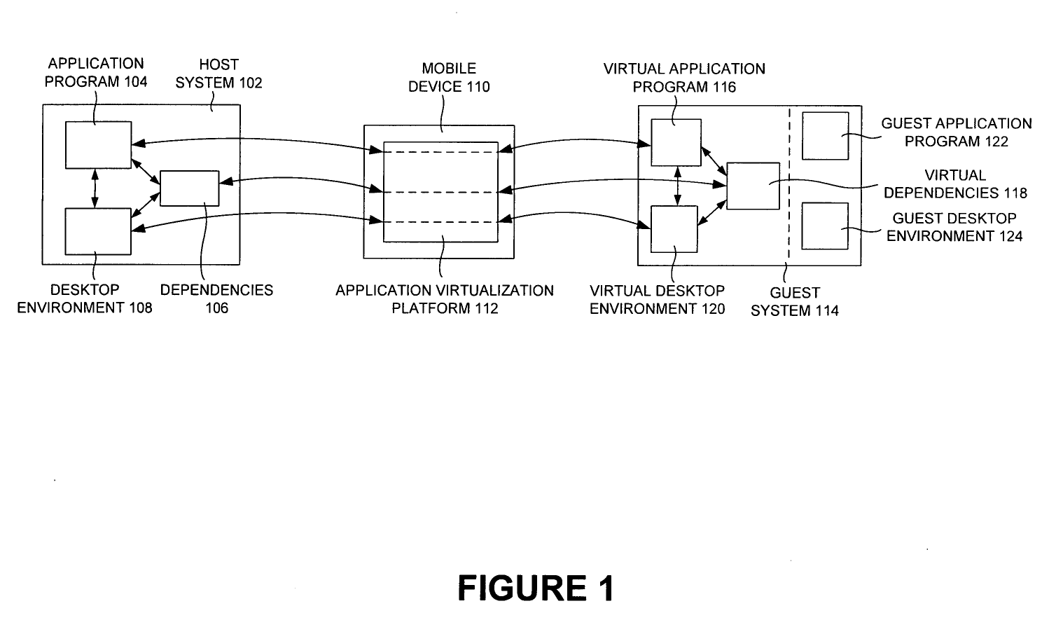

In one embodiment, a method includes capturing dependencies (e.g., dependencies 106 of FIG. 1) of an application program (e.g., an application program 104 of FIG. 1) associated with a host system (e.g., a host system 102 of FIG. 1), directly replicating to a removable device the application program, a desktop environment of the host system, and the dependencies, and resurrecting the dependencies to run the application program under the desktop environment agnostic to a guest operating system (OS) of a guest system (e.g., a guest system 114 of FIG. 1) while the removable device is coupled to the guest system.

In another embodiment, a method, includes capturing a host state of a host system immediately prior to directly installing an application program to a removable device (e.g., a mobile device 110 of FIG. 1), replicating the host state and changes of the host state to the removable device based on the changes of the host state captured during the installation of the application program to the removable device, deleting the changes and reinstating a dynamically linked library (DLL) of the host state to the host system to restore the host state to the host system, capturing a guest state of a guest system immediately prior to coupling the removable device to the guest system and changes of the guest state during the coupling, and deleting the changes and reinstating a dynamically linked library (DLL) of the guest state to the guest system to restore the guest state to the guest system.

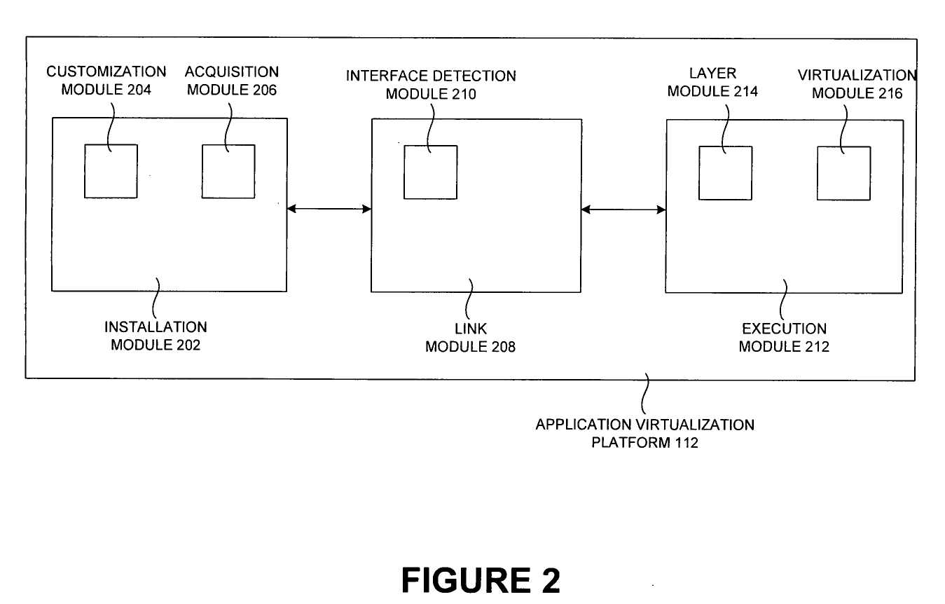

In yet another embodiment, a removable device includes an installation module (e.g., an installation module 208 of FIG. 2) of an application virtualization platform (e.g., an application virtualization platform 112 of FIG. 1) to replicate to a removable device through a host system with any one of the application program (e.g., an application program 104 of FIG. 1), a desktop environment (e.g., a desktop environment 108 of FIG. 1) of the host system, and dependencies of the application program associated with the host system, a link module (e.g., a link module 208 of FIG. 2) of the application virtualization platform to load the application program, the desktop environment (e.g., the desktop environment 108 of FIG. 1), and the dependencies (e.g., the dependencies 106 of FIG. 1) to a guest system when the removable device is coupled to the guest system and an execution module (e.g., an execution module 212 of FIG. 2) of the application virtualization platform to generate a virtual environment such that the application program operates agnostic to an operating system (OS) of the guest system.

FIG. 1 is a system view of the mobile device 110 having the application virtualization platform 112 communicating with the host system 102 and the guest system 114, according to one embodiment. Particularly, FIG. 1 illustrates the host system 102, the application program 104, the dependencies 106, the desktop environment 108, the mobile device 110, the application virtualization platform 112, the guest system 114, a virtual application program 116, virtual dependencies 118, a virtual desktop environment 120, a guest application program 122 and a guest desktop environment 124, according to one embodiment. The host system 102 may be a data processing system (e.g., a computer) that provides services to other system and/or user.

The application program 104 may be a program designed to perform a specific function for the user and/or for another application program. For example, the application program 104 may be a word processor, a database program, a web browser, a development tool, a drawing, paint, and/or image editing program and/or a communication program. The dependencies 106 may allow the user to control the circumstances under which an application may be installed and/or an action may be executed. The desktop environment 108 may offer a graphical user interface to the host system 102 typically providing icons, windows, toolbars, folders, wallpapers, and drag and drop features on the host system 102.

The mobile device 110 may be a USB drive (e.g., an optical disk such as a CD, a laser disk, a mini disk, a DVD, a blue-ray disk, etc.) with a flash memory for launching the application program 104 on the guest system 114. The application virtualization platform 112 may be a platform on which the virtual application program 116 runs. The guest system 114 may be a guest computer, a guest laptop, a guest PDA, and/or other device that acts as a client to the host system. The virtual application program 116 may be an application program of the mobile device 110 that runs on the guest system 114. The virtual dependencies 118 may allow the user to control circumstances on the guest computer on which the virtual application program 116 may be executed.

The virtual desktop environment 120 may offer a virtual graphical user interface of the virtual application program 116 on the guest system 114 through providing the icons, windows, toolbars, folders, wallpapers, and/or drag and drop features. The guest application program 122 may be a program designed to perform a specific function directly for the user and/or another application program supporting the virtual application program 116. The guest desktop environment 124 may be a graphical user interface of the guest system 114 which features icons, windows, toolbars, folders, wallpapers, and/or a drag and/or drop function.

In example embodiment illustrated in FIG. 1, the host system 102 which includes the application program 104, the dependencies 106 and the desktop environment 108 interacts with the application virtualization platform 112 of the mobile device 110 to install the application program 104, the desktop environment 108, and the dependencies 106. The mobile device 110 interacts with the guest system 114 to launch the virtual application program 116, the virtual dependencies 118 and/or virtual desktop environment 120.

For example, dependencies (e.g., the dependencies 106) of an application program (e.g., the application program 104) associated with a host system (e.g., the host system 102) may be captured. The application program, a desktop environment (e.g., the desktop environment 108) of the host system, and the dependencies may be directly replicated on a removable device (e.g., the mobile device 110). In addition, the dependencies may be resurrected to run the application program under the desktop environment agnostic to a guest operating system (OS) of the guest system (e.g., the guest system 114 of FIG. 1) while the removable device is coupled to the guest system.

Furthermore, the desktop element of the host system may be duplicated to the desktop environment of the removable device, wherein the at least one desktop element to include at least one of the icon, the toolbar, the wall paper, and/or the document. Also, a user name and a password associated with the removable device may be stored to access the desktop environment when the removable device is coupled to the guest system.

Moreover, the application program may be executed faster on the guest system than on the host system by at least 20% through a performance tuning (e.g., the performance tuning may be obtained through at least one of a code optimization, a load balancing, a caching strategy, and a distributed computing) of an application program interface (API) of the application program embedded in the removable device. The desktop environment of the removable device and/or the desktop environment of the guest system may be switched.

Furthermore, the application program of the removable device may be isolated from any application program of the guest system to prevent any conflict between the application program of the removable device and the any application program (e.g., the guest application program 122) of the guest system. In addition, the host system and the guest system may be a personal computer and the removable device may be a USB drive with a flash memory.

Also, the host state (e.g., which may include a state of a registry and/or a state of a file system) of the host system may be captured immediately prior to directly installing the application program to the removable device. Also, the host state and changes of the host state to the removable device may be replicated based on the changes of the host state captured during the installing the application program to the removable device. The changes may be deleted and the dynamically linked library (DLL) of the host state may be reinstated to the host system to restore the host state to the host system.

Furthermore, a guest state (e.g., which may include at least a state of a registry and a state of a file system) of a guest system may be captured immediately prior to coupling the removable device to the guest system and changes of the guest state during the coupling. Also, the changes may be deleted and the dynamically linked library (DLL) of the guest state may be reinstated to the guest system to restore the guest state to the guest system.

In addition, the changes of the registry of the host system and the changes of the registry of the guest system may be captured through turning on a security auditing and capturing the changes of the file system of the host system and the changes of the file system of the guest system thorough activating a file system watcher. Moreover, the changes to the removable device may be replicated when the removable device is decoupled from the guest system.

FIG. 2 is an exploded view of the application virtualization platform 112 of FIG. 1, according to one embodiment. Particularly, FIG. 2 illustrates an installation module 202, a customization module 204, an acquisition module 206, a link module 208, an interface detection module 210, an execution module 212, a layer module 214 and a virtualization module 216, according to one embodiment.

The installation module 202 may replicate to the removable device through the host system (e.g., the host system 102 of FIG. 1) with the application programs, the desktop environment (e.g., the desktop environment 108 of FIG. 1) of the host system, and/or dependencies (e.g., the dependencies 106 of FIG. 1) of the application program (e.g., the application program 104 of FIG. 1) associated with the host system. The customizable module 204 may selectively replicate the desktop environment of the host system to the removable device through enabling the user of the removable device to selectively import the desktop elements to the removable device.

The acquisition module 206 may detect and/or capture the dependencies (e.g., the dependencies 106 of FIG. 1) of the application program in the mobile device (e.g., the mobile device 110). The link module 208 may load the application program, the desktop environment, and the dependencies to the guest system (e.g., the guest system 114) when the removable device is coupled to the guest system. The interface detection module 210 may determine coupling and decoupling of the removable device from the guest system. The execution module 212 may generate a virtual environment such that the application program operates agnostic to the operating system (OS) of the guest system.

The layer module 214 may create a rule based virtualization layer through hooking the application program interface (API) of the application program and installing at least one handler associated with the application program. The virtualization module 216 may create the virtual environment through virtualizing calls associated with a registry, a file system, and the API of the application program such that the application program operates under the virtual environment using the at least one handler.

In example embodiment illustrated in FIG. 2, the application virtualization platform 112 includes the installation module 202 having customization module 204 and acquisition module 206 that communicates with the link module 208 having interface detection module 210 that further communicates with the execution module 212 having layer module 214 and virtualization module 216.

For example, an installation module (e.g., the installation module 202) of an application virtualization platform (e.g., the application virtualization platform 112 of FIG. 1) may replicate to a removable device (e.g., the mobile device 110) through a host system (e.g., the host system 102) with at least one application program, a desktop environment of the host system, and dependencies of the application program associated with the host system. Also, a link module (e.g., the link module 208) of the application virtualization platform may load the application program, the desktop environment, and the dependencies to a guest system when the removable device is coupled to the guest system. An execution module (e.g., the execution module 212) of the application virtualization platform may generate a virtual environment such that the application program operates agnostic to an operating system (OS) of the guest system.

In addition, a customization module (e.g., the customization module 204) may selectively replicate the desktop environment of the host system to the removable device through enabling a user of the removable device to selectively import a plurality of desktop elements to the removable device. Furthermore, an acquisition module (e.g., the acquisition module 206) of the installation module may detect and capture any one of the dependency of the application program. Also, an interface detection module (e.g., the interface detection module 210) of the link module to determine at least one of a coupling and a decoupling of the removable device from the guest system.

A layer module (e.g., the layer module 214) of the execution module may create a rule based virtualization layer through hooking the application program interface (API) of the application program and installing at least one handler associated with the application program. Moreover, a virtualization module (e.g., the virtualization module 216) of the execution module to create the virtual environment through virtualizing calls associated with a registry, a file system, and the API of the application program such that the application program operates under the virtual environment using the at least one handler.

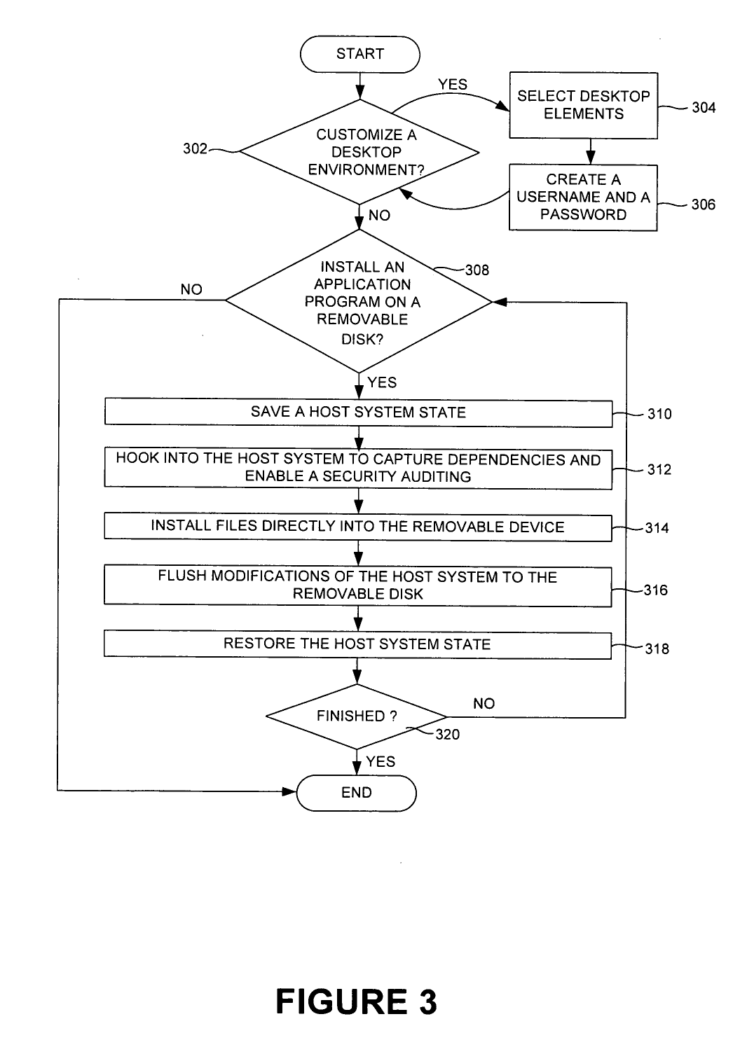

FIG. 3 is a process view of the installation module 202 of FIG. 2, according to one embodiment. In operation 302, a user may be asked to customize the desktop environment (e.g., the desktop environment 108 of FIG. 1). In operation 304, desktop elements may be selected. In operation 306, a username and a password may be created. In operation 308, the user may be asked to install an application program on a removable disk.

In operation 310, a state of the host system (e.g., which hosts the desktop environment and/or the application program) may be saved. In operation 312, the host system to capture dependencies (e.g., the dependencies 106 of FIG. 1) and enable a security auditing may be hooked. In operation 314, the files (e.g., the application program, the desktop environment, and/or the dependencies) may be directly installed into the removable disk. In operation 316, modifications of the host system to the removable disk may be flushed. In operation 318, the state of the host system may be restored. In operation 320, the user may be asked whether installation of the application program is completed. Depending on the user's answer, the process may continue or terminate.

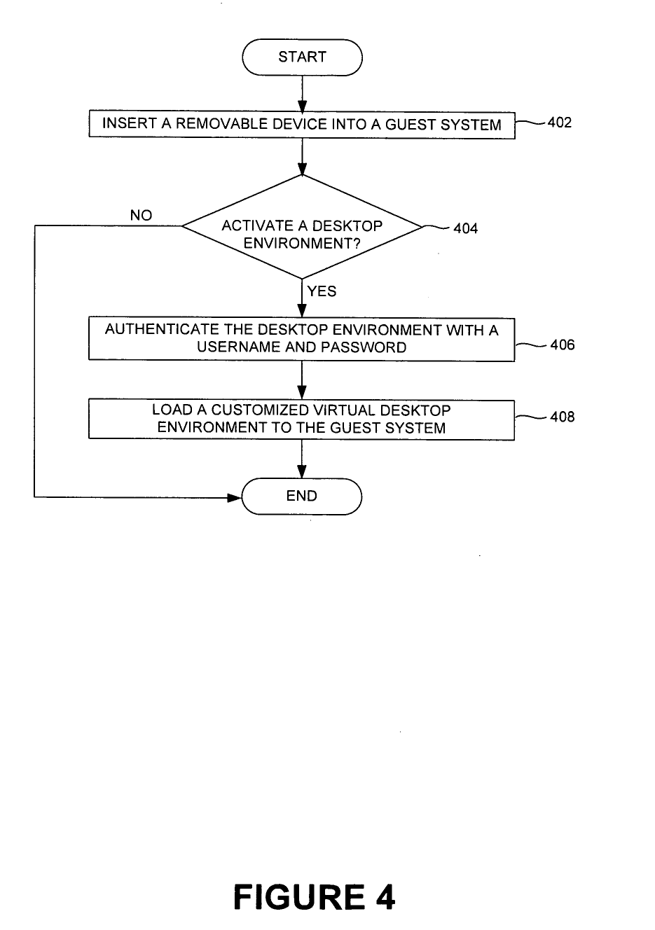

FIG. 4 is a process view of the link module 208 of FIG. 2, according to one embodiment. In operation 404, a user may be asked to activate a desktop environment. In operation 406, the desktop environment (e.g., the desktop environment 108 of FIG. 1) may be authenticated with a user name and password. In operation 408, a customized virtual desktop environment may be loaded to the guest system (e.g., the guest system 114 of FIG. 1).

In one example embodiment, the user name and the password communicated to the removable device may be matched to authenticate a user of the removable device when the removable device is coupled to the guest system.

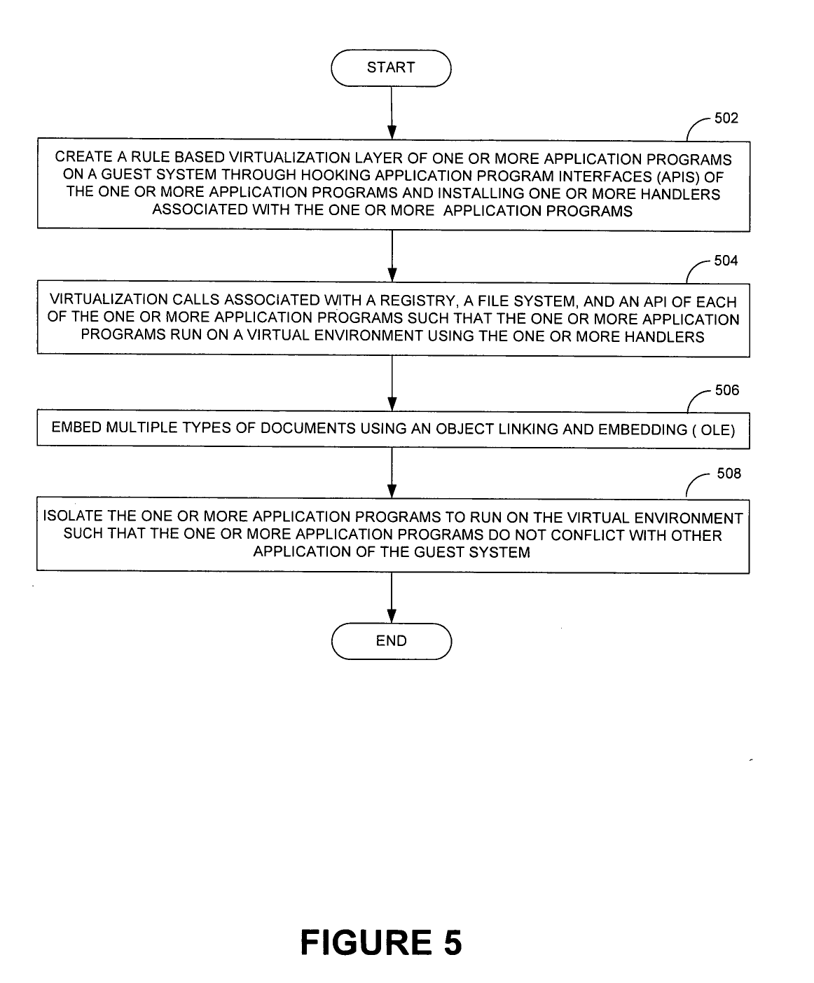

FIG. 5 is a process view of the execution module 212 of FIG. 2, according to one embodiment. In operation 502, a rule based virtualization of one or more application programs may be created on a guest system (e.g., the guest system 114 of FIG. 1) through hooking application program interface of the one or more application program and installing one or more handlers associated with the one or more application program (e.g., the application program 104 of FIG. 1).

In operation 504, calls associated with a registry, a file system, and an API of each of the one or more application program may be virtualized such that the one or more application programs run on a virtual environment using the one or more handlers. In operation 506, multiple types of documents may be embedded using an object linking and embedding (OLE). In operation 508, one or more application program may be isolated to run on the virtual environment such that the one or more application programs do not conflict with other application of the guest system.

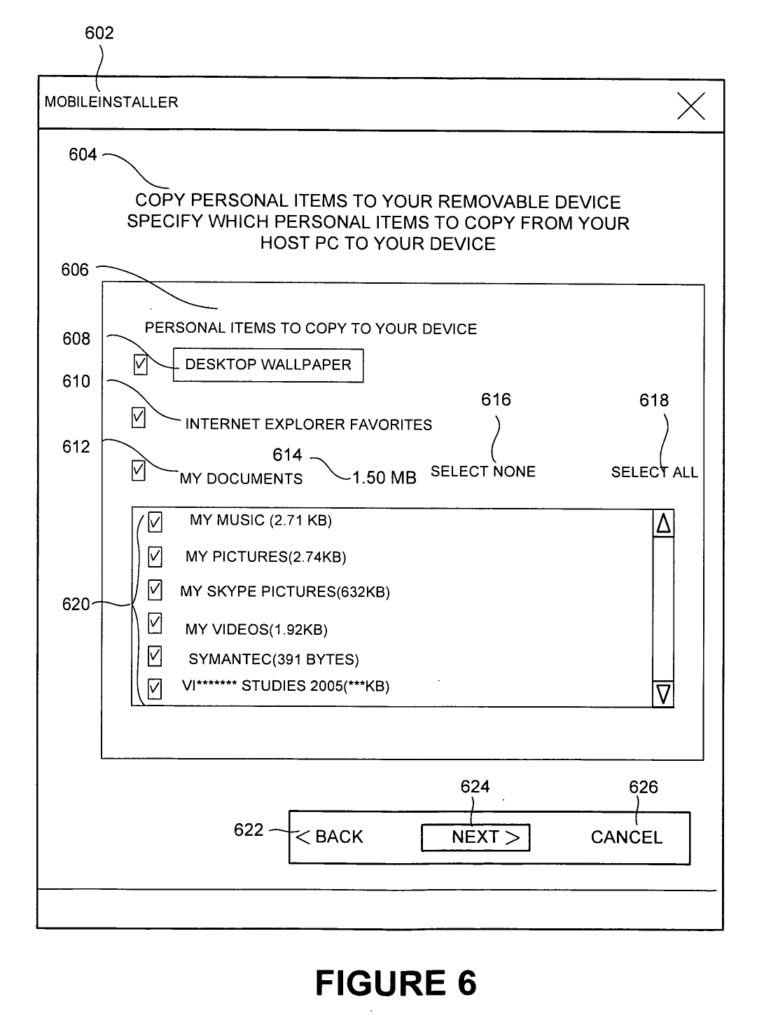

FIG. 6 is a user interface view of the customization module 204 (e.g., a mobileinstaller 602), according to one embodiment. The customization module 204 may customize the user's mobile desktop or a mobile device (e.g., the mobile device 110 of FIG. 1). The option 604 may copy personal items (e.g., an icon, a toolbar, a wall paper, and/or a document) to a removable device and/or specify which personal items to copy from the host system (e.g., the host system 102 of FIG. 1) to the removable device. The personal items to copy to the removable device 606 may be desktop elements of the host system (e.g., the host system 102) to be replicated to the removable device. The desktop wallpaper 608 may be used as a background on a computer screen.

The internet explorer favorites 610 may enable a user to add a page as one of the user's favorites. My documents 614 may be a special folder on a computer hard drive that is commonly used to store the user's documents (e.g., my music 620, my picture 620, my skype pictures 620, my videos 620, Symantec 620, and other files). The select none 616 and select all 618 may be an option to select a choice of the user. The option back 622 may enable the user to view a previous page of the mobileinstaller 602. The next 624 may enable the user to view subsequent pages of the mobileinstaller 602. The option cancel 626 may enable the user to exit from the mobileinstaller 602.

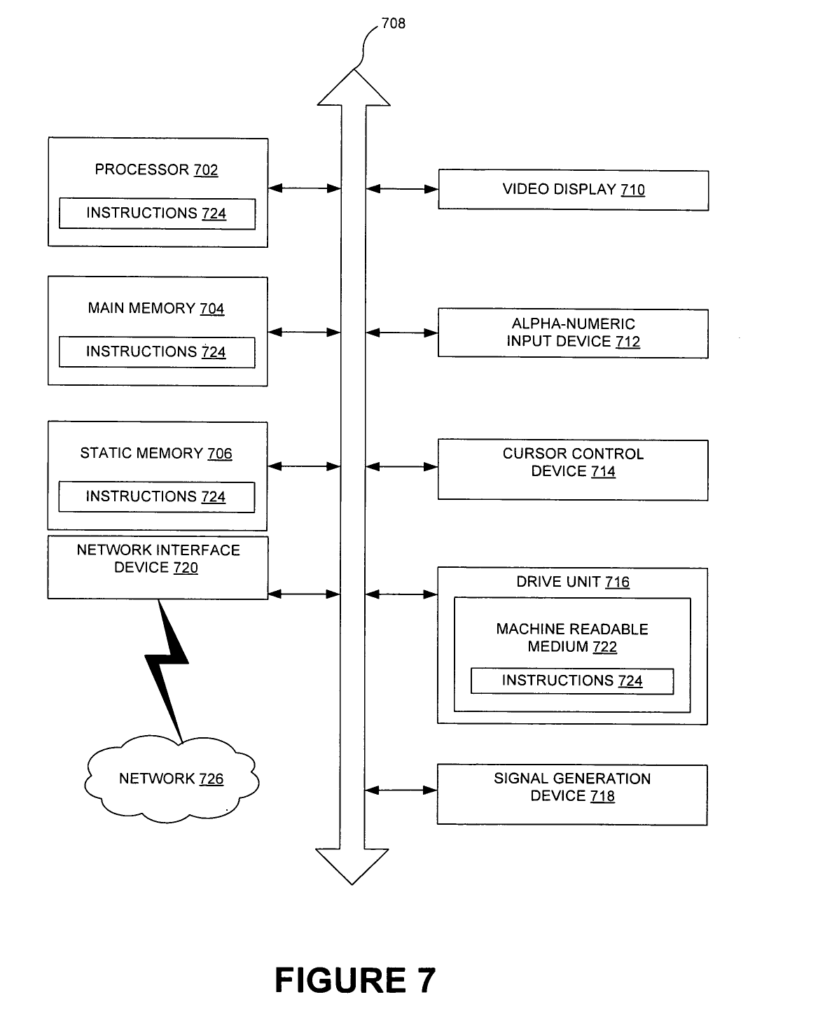

FIG. 7 is a diagrammatic system view, according to one embodiment. FIG. 7 is a diagrammatic system view 700 of a data processing system in which any of the embodiments disclosed herein may be performed, according to one embodiment. Particularly, the diagrammatic system view 700 of FIG. 7 illustrates a processor 702, a main memory 704, a static memory 706, a bus 708, a video display 710, an alpha-numeric input device 712, a cursor control device 714, a drive unit 117, a signal generation device 718, a machine readable medium 722, instructions 724, and a network 726, according to one embodiment.

The diagrammatic system view 700 may indicate a personal computer and/or a data processing system in which one or more operations disclosed herein are performed. The processor 702 may be microprocessor, a state machine, an application specific integrated circuit, a field programmable gate array, etc. (e.g., Intel® Pentium® processor). The main memory 704 may be a dynamic random access memory and/or a primary memory of a computer system.

The static memory 706 may be a hard drive, a flash drive, and/or other memory information associated with the data processing system. The bus 708 may be an interconnection between various circuits and/or structures of the data processing system. The video display 710 may provide graphical representation of information on the data processing system. The alpha-numeric input device 712 may be a keypad, keyboard and/or any other input device of text (e.g., a special device to aid the physically handicapped). The cursor control device 714 may be a pointing device such as a mouse.

The drive unit 716 may be a hard drive, a storage system, and/or other longer term storage subsystem. The signal generation device 718 may be a bios and/or a functional operating system of the data processing system. The network interface device 720 may be a device that may perform interface functions such as code conversion, protocol conversion and/or buffering required for communication to and from a network. The machine readable medium 722 may provide instructions on which any of the methods disclosed herein may be performed. The instructions 724 may provide source code and/or data code to the processor 702 to enable any one/or more operations disclosed herein.

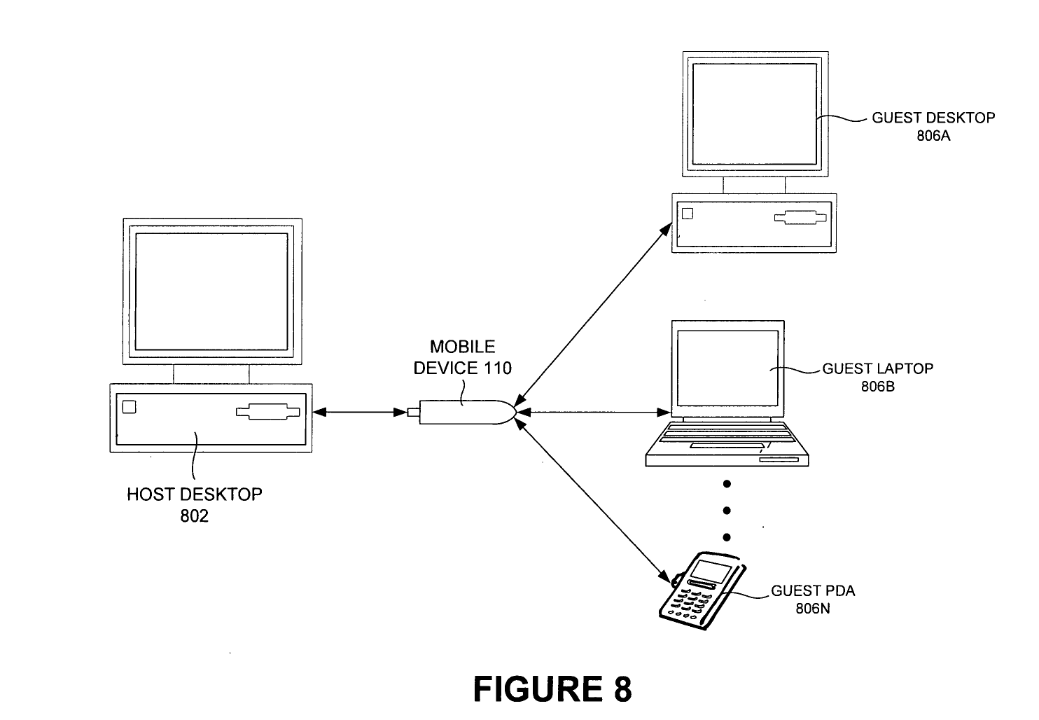

FIG. 8 is a schematic view of replicating an application program from a host computer to a guest computer by using a removable device, according to one embodiment. Particularly, FIG. 2 illustrates a host desktop 802, the mobile device 110, a guest desktop 806A, a guest laptop 806B and a guest PDA 806N. The host desktop 802 may be a personal computer where the user has an administrative privilege. The mobile device 110 may be a USB drive with a flash memory used to launch the application on guest system. The guest desktop 806A and the guest laptop 806B may be a computer where the user does not have the administrative privilege. The guest PDA 806N may be an electronic device with functionalities of a computer, a cellphone, a music player and/or a camera.

In example embodiment illustrated in FIG. 8, the mobile device 110 may be a USB device with a flash memory which replicates and loads an application program (e.g., the application program 104 of FIG. 1), a desktop environment (e.g., the desktop environment 108) and dependencies (e.g., the dependencies 106) from the host desktop 802 to the guest desktop 806A, the guest laptop 806B, and/or the guest PDA 806N. The host desktop 802 interacts with the guest devices (806A-N) through the mobile device 804.

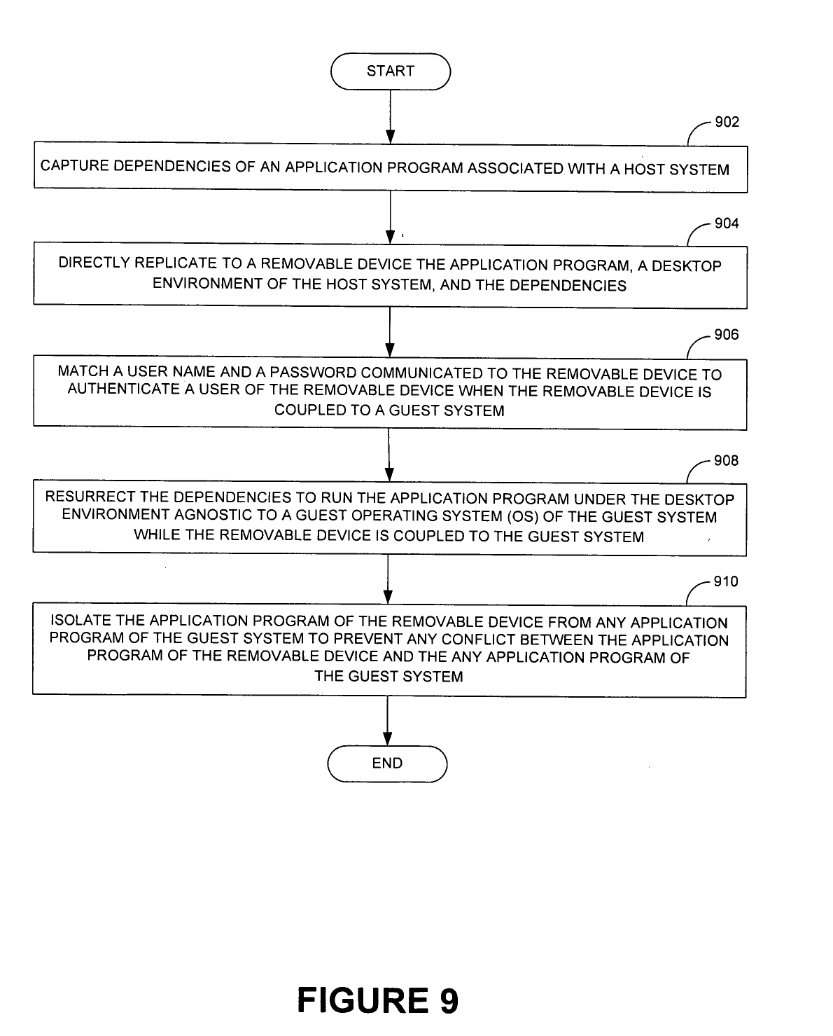

FIG. 9 is a process flow chart of capturing the application program 104, the desktop environment 108, and the dependencies 106 of the host system 102 of FIG. 1 using the mobile device 110, according to one embodiment. In operation 902, the dependencies (e.g., the dependencies 106 of FIG. 1) of the application program (e.g., the application program 104 of FIG. 1) associated with a host system (e.g., the host system 102 of FIG. 1) may be captured. In operation 904, the application program, a desktop environment of the host system, and the dependencies may be directly replicated to the removable device. In operation 906, the user name and the password communicated to the removable device may be matched to authenticate a user of the removable device when the removable device is coupled to a guest system (e.g., the guest system 114 of FIG. 1).

In operation 908, the dependencies may be resurrected to run the application program under the desktop environment agnostic to a guest operating system (OS) of the guest system while the removable device is coupled to the guest system. In operation 910, the application of the removable device may be isolated from any application program of the guest system to prevent any conflict between the application program of the removable device and the any application program of the guest system.

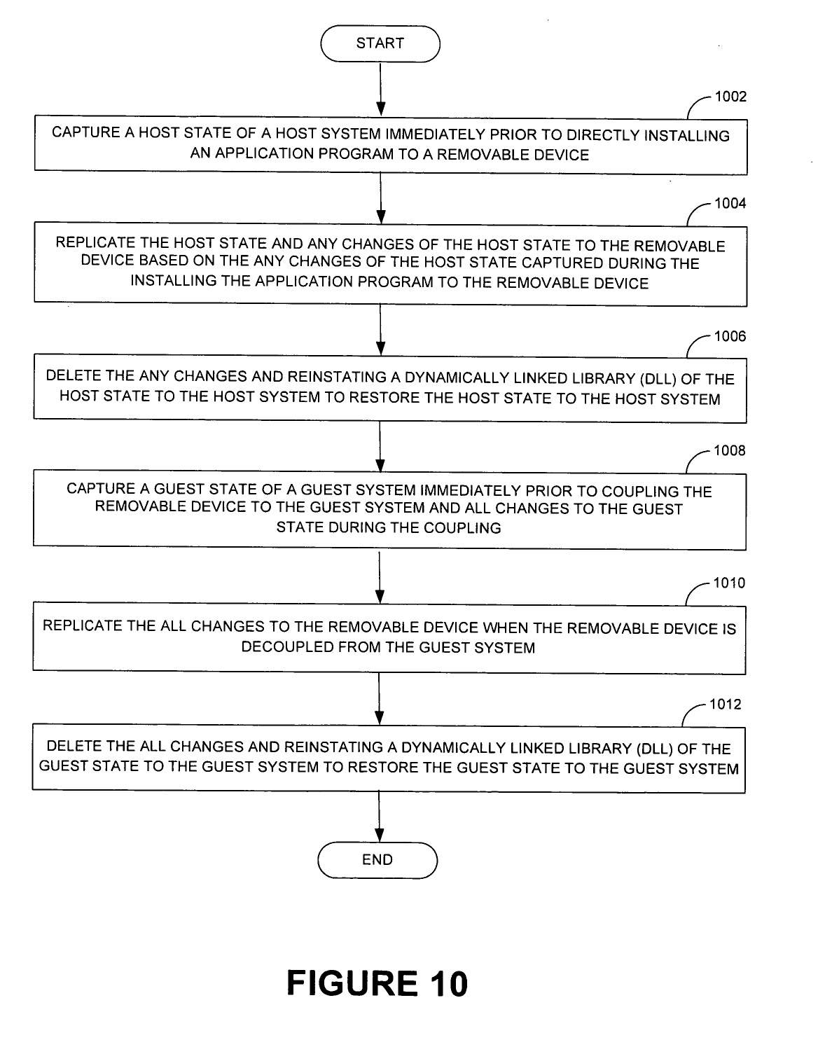

FIG. 10 is a process flow chart of capturing, replicating, and/or deleting a host state and/or a guest state using the mobile device 110 of FIG. 1, according to one embodiment. In operation 1002, a host state of a host system may be captured immediately prior to directly installing an application program (e.g., the application program 104 of FIG. 1) to a removable device (e.g., the mobile device 110). In operation 1004, the host state and any changes of the host state to the removable device may be replicated based on the any changes of the host state captured during the installing the application program (e.g., the application program 104 of FIG. 1) to the removable device. In operation 1006, the host state to the host system (e.g., the host system 102 of FIG. 1) may be restored by deleting the any changes and reinstating a dynamically linked library (DLL) of the host state to the host system to restore the host state to the host system.

In operation 1008, a guest state of the guest system (e.g., the guest system 114 of FIG. 1) may be captured immediately prior to coupling the removable device to the guest system (e.g., the guest system 114 of FIG. 1) and all the changes to the guest state during the coupling. In operation 1010, all the changes to the removable device may be replicated when the removable device is decoupled from the guest system. In operation 1012, the guest state to the guest system may be restored by deleting the all changes and reinstating a dynamically linked library (DLL) of the guest state to the guest system.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium).

For example the installation module 202, the customization module 204, the acquisition module 206, the link module 208, the interface detection module 210, the execution module 212, the layer module 214, the virtualization module 216 and other modules of FIGS. 1 through 10 may be embodied through an installation circuit, a customization circuit, a acquisition circuit, a link circuit, a interface detection circuit, a execution circuit, a layer circuit, a virtualization circuit and other circuits using one or more of the technologies described herein.

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1. A method, comprising:
capturing dependencies of an application program associated with a host system;
directly replicating to a removable device the application program, a desktop environment of the host system, and the dependencies; and
resurrecting the dependencies to run the application program under the desktop environment agnostic to a guest operating system (OS) of a guest system while the removable device is coupled to the guest system.

2. The method of claim 1 wherein the dependencies to include at least a host operating system to provide a memory and a disk space, a host file system to read and write data, and a host registry to store and retrieve the data.

3. The method of claim 2 further comprising duplicating at least one desktop element of the host system to the desktop environment of the removable device, wherein the at least one desktop element to include at least one of an icon, a toolbar, a wall paper, and a document.

4. The method of claim 3 further comprising storing a user name and a password associated with the removable device to access the desktop environment when the removable device is coupled to the guest system.

5. The method of claim 4 further comprising executing the application program faster on the guest system than on the host system by at least 20% through a performance tuning of an application program interface (API) of the application program embedded in the removable device, wherein the performance tuning is obtained through at least one of a code optimization, a load balancing, a caching strategy, and a distributed computing.

6. The method of claim 5 further comprising matching the user name and the password communicated to the removable device to authenticate a user of the removable device when the removable device is coupled to the guest system.

7. The method of claim 6 further comprising switching between the desktop environment of the removable device and a desktop environment of the guest system.

8. The method of claim 7 further comprising isolating the application program of the removable device from any application program of the guest system to prevent any conflict between the application program of the removable device and the any application program of the guest system.

9. The method of claim 1 wherein each of the host system and the guest system is a personal computer and the removable device is a USB drive with a flash memory.

10. The method of claim 1 in a form of a machine-readable medium embodying a set of instructions that, when executed by a machine, causes the machine to perform the method of claim 1.

11. A method, comprising:
capturing a host state of a host system immediately prior to directly installing an application program to a removable device;
replicating the host state and changes of the host state to the removable device based on the changes of the host state captured during the installing the application program to the removable device;
deleting the changes and reinstating a dynamically linked library (DLL) of the host state to the host system to restore the host state to the host system;
capturing a guest state of a guest system immediately prior to coupling the removable device to the guest system and changes of the guest state during the coupling; and
deleting the changes and reinstating a dynamically linked library (DLL) of the guest state to the guest system to restore the guest state to the guest system.

12. The method of claim 111 wherein the host state to include at least a state of a registry of the host system and a state of a file system of the host system, and wherein the guest state to include at least a state of a registry of the guest system and a state of a file system of the guest system.

13. The method of claim 12 further comprising capturing the changes of the registry of the host system and the changes of the registry of the guest system through turning on a security auditing and capturing the changes of the file system of the host system and the changes of the file system of the guest system thorough activating a file system watcher.

14. The method of claim 13 further comprising replicating the changes to the removable device when the removable device is decoupled from the guest system.

15. A removable device, comprising:
an installation module of an application virtualization platform to replicate to a removable device through a host system with at least one application program, a desktop environment of the host system, and dependencies of the application program associated with the host system;
a link module of the application virtualization platform to load the application program, the desktop environment, and the dependencies to a guest system when the removable device is coupled to the guest system; and
an execution module of the application virtualization platform to generate a virtual environment such that the application program operates agnostic to an operating system (OS) of the guest system.

16. The removable device of claim 15 further comprising a customization module to selectively replicate the desktop environment of the host system to the removable device through enabling a user of the removable device to selectively import a plurality of desktop elements to the removable device.

17. The removable device of claim 16 further comprising an acquisition module of the installation module to detect and capture at least one dependency of the application program.

18. The removable device of claim 17 further comprising an interface detection module of the link module to determine at least one of a coupling and a decoupling of the removable device from the guest system.

19. The removable device of claim 18 further comprising a layer module of the execution module to create a rule based virtualization layer through hooking the application program interface (API) of the application program and installing at least one handler associated with the application program.

20. The removable device of claim 19 further comprising a virtualization module of the execution module to create the virtual environment through virtualizing calls associated with a registry, a file system, and the API of the application program such that the application program operates under the virtual environment using the at least one handler.
